(19) United States
(12) Patent Application Publication
(10) Pub. No.: US 2011/0259063 A1
(43) Pub. Date: Oct. 27, 2011

(54) ALARM LOCK

(76) Inventor: Ivan Foti, Hong Kong (CN)

(21) Appl. No.: 12/934,971

(22) PCT Filed: Mar. 20, 2009
(86) PCT No.: PCT/GB09/00767

§ 371 Date: Nov. 23, 2010

(30) Foreign Application Priority Data
Mar. 27, 2008 (GB) 0805601.2

(51) Int. Cl. E05B 45/00; E05B 35/00; E05B 15/00

(52) U.S. Cl. 70/344; 70/441; 70/266

(57) ABSTRACT

A lock has a body (10) holding a locking member (11) that can be locked to or released from the body (10) by, for example, operation of a key (21). The lock includes an alarm (25) that is triggered by the locking of the locking member (11). If, however, the lock is unlocked and relocked within a predetermined time interval, the alarm (25) is disarmed. In this way, the lock can remain locked but with the alarm (25) disarmed. The signals that cause the alarm (25) to arm and disarm can be produced in any convenient way.

The invention relates to locks and more particularly to locks incorporating an alarm.

It is known to provide a lock comprising a body and a locking member lockable to the body and unlockable for opening movement relative to the body, the body including an alarm and an alarm trigger operable, when the locking member is locked to the body, to activate the alarm. The alarm trigger can, for example, be operated by a locking movement of a key or the operation of a push-button to lock the locking member.

It is a problem with such locks that, while it is desirable to have the alarm operable when the lock is locking a device against use, there may be occasions when it is required to have the lock member in the locked position but to have the alarm inoperative. This might, for example, be when the lock is being transported. There is a danger that the alarm will operate in such circumstances.

According to the invention, there is provided lock comprising a body and a locking member lockable to the body and unlockable for opening movement relative to the body, the body including an alarm and an alarm trigger operable, when the locking member is locked to the body, in a first mode to activate the alarm and in a second mode to render the alarm inoperative.

Thus, by providing the second mode of operation of the alarm trigger, the lock can have the locking member in the locked position but have the alarm inoperative. The lock can be transported in this configuration without the alarm operating.

The following is a more detailed description of some embodiments of the invention, by way of example, reference being made to the accompanying drawings in which:—

FIG. 1 is a cross-section of a padlock including a body, a locking member and a barrel incorporating an alarm and a control circuit,

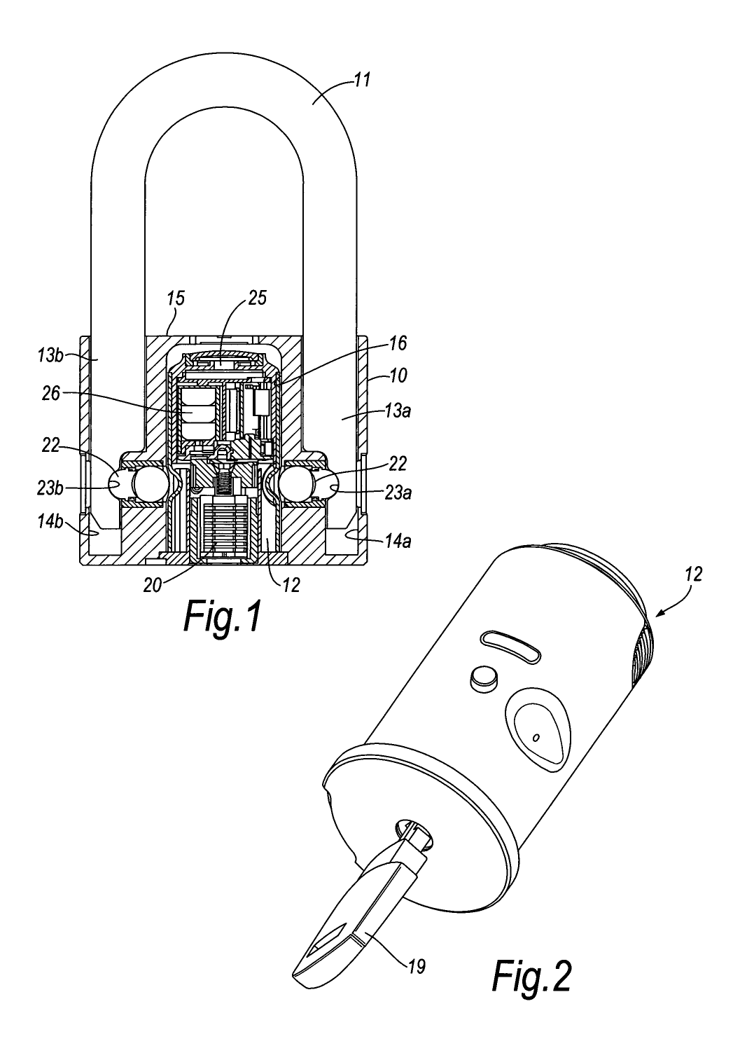

FIG. 2 is a perspective view of the barrel, with a key in the barrel,

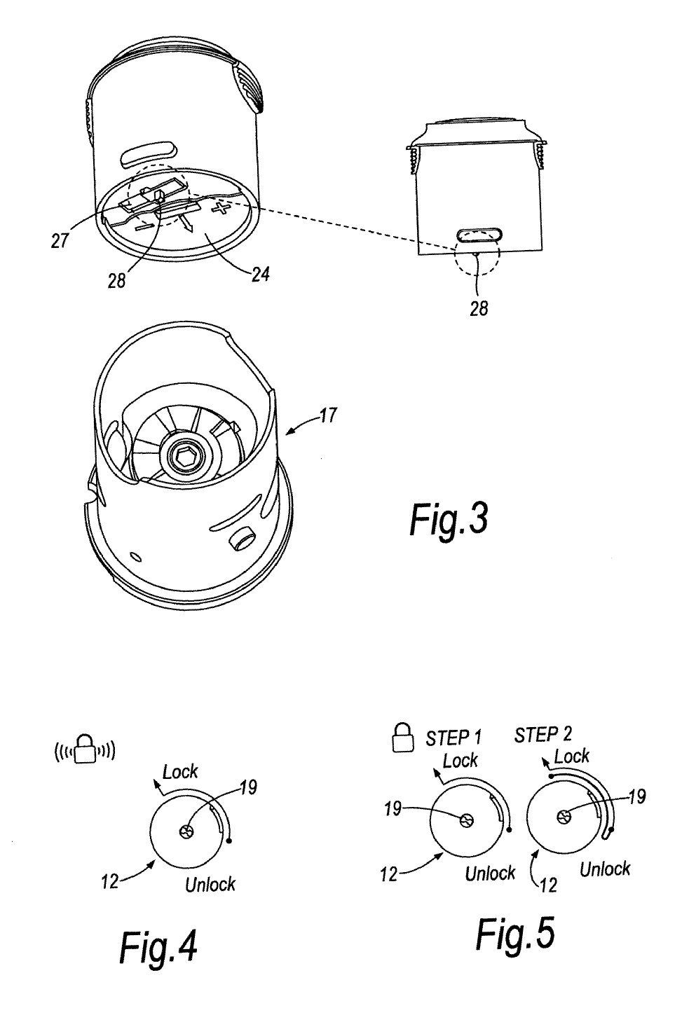

FIG. 3 is an exploded view of the barrel of FIG. 2 showing a locking unit and an electronics module, the electronics module also being shown in side elevation,

FIG. 4 is a diagram showing the activation of the alarm,

FIG. 5 is a diagram showing the subsequent rendering of the alarm inactive, and

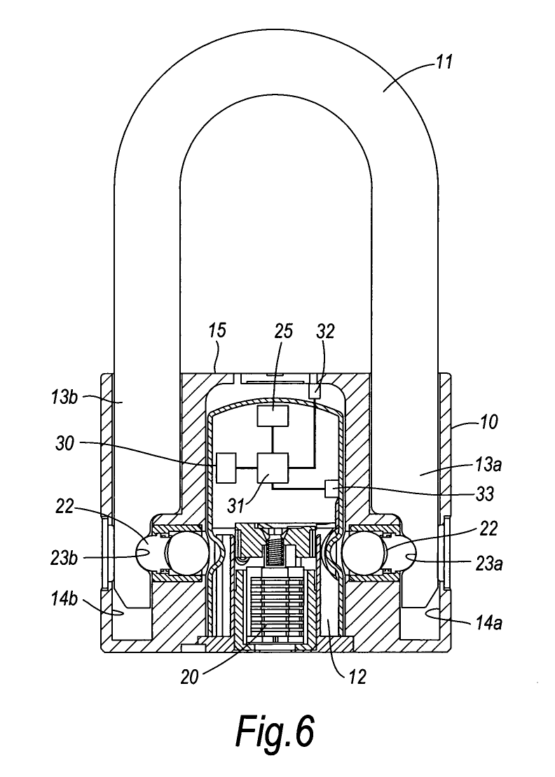

FIG. 6 is a similar view to FIG. 1 but with the control circuit operable by a sensor and/or an infra-red detector.

Referring first to FIG. 1, the padlock comprises a body 10, a U-shaped locking member 11 and a barrel 12. The locking member 11 has arms 13a, 13b received in respective passages 14a, 14b in a first end face 15 of the body 10. The arms 13a, 13b and the passages 14a, 14b may be of circular cross-section, but this is not essential.

The barrel 12 is received in a bore 16 in the body 10 extending into the body 10 from a second end of the body 10 and closed at the opposite end. The barrel 10 and the bore 16 may be of circular cross-section. The barrel 12 is formed from two axially spaced parts—a locking unit 17 and an electronics module 18. The locking unit 17 is closer to the open end of the body 10 and the electronics module 18 at the closed end. The locking unit 17 is operated by a key 19 and includes a mechanism 20 that converts rotation of the key 21 in one sense into radially outward movement of two pins 22 held by the body 10 to engage respective recesses 23a, 23b formed towards respective ends of the arms 13a, 13b when the arms 13a, 13b are received in the passages 14a, 14b. In this way, the locking member 11 is locked to the body 10. Mechanisms of this kind are known and will not be described in further detail.

The electronics module 18 contains a battery 24, an alarm 25 and an alarm control circuit 26. In addition, a switch 27 is carried on an end face of the electronics module 18 and includes a pin 28 that engages the locking mechanism 20 so that rotation of the mechanism moves the pin 28 to operate the switch 27. The switch 27 is connected to the alarm control circuit 26, which is, in turn, connected to the alarm 25. The alarm control circuit 26 and the alarm 25 are powered by the battery 24.

In use, the key 21 is rotated clockwise as seen in FIG. 2 to unlock the locking mechanism 20, so allowing the pins 22 to retract and release the locking member 11 for disengagement from the body 10 by removal of the arms 13a, 13b from the passages 14a, 14b. The locking member 11 can then be passed through part of a device to be locked, which might, for example, be a hole in a disc of a disc brake of a motorcycle (not shown) and the arms 13a, 13b re-inserted into the passages 14a, 14b. The key 21 is then turned anti-clockwise as seen in FIG. 4. The effect of this is to extend the pins 22 to engage the respective recesses 23a, 23b of the arms 13a, 13b, so locking the locking member 11 to the body 10.

This rotation of the key 21 also moves the pin 28 to operate the switch 27. This passes an electrical signal to the alarm control circuit 26 that, in turn, triggers the alarm 25. At the same time, the alarm control circuit 26 emits a short duration sound to indicate to the user of the lock that the alarm 25 is operative.

If nothing further is done after these steps, the alarm 25 remains armed and will operate if there is unauthorised interference with the lock. After a predetermined time interval, which may, for example, be 5 seconds, the alarm control circuit 26 emits a longer duration sound to confirm arming.

If, however, within the predetermined time interval, the key 21 is turned to unlock and re-lock the lock (see FIG. 5), then the switch 27 is operated again and sends an additional signal to the alarm control circuit 26. On receipt of this signal within the time interval, the alarm control circuit 26 renders the alarm 25 inoperative. At the same time, the alarm control circuit 26 emits a two sounds of shorter duration than the duration of the “confirm arming” sound to indicate that the alarm 25 is no longer armed.

Of course, if the unlocking and re-locking takes place outside the time interval, the alarm 25 remains armed.

In this way, the lock can be locked either with the alarm 25 armed or disarmed. The alarm 25 may be disarmed when, for example, the lock is transported or if the lock is used in circumstances where an alarm 25 would be too intrusive.

Of course, there are a number of alterations that could be made to the lock described above with reference to the drawings. The lock need not be operated by a key 21. It could be operated by a push-button, key pad or any other convenient operating mechanism. In the lock described above with reference to the drawings, the lock is armed when a first signal is received by the alarm control circuit 25 and disarmed if an additional signal is received within a predetermined time interval.

These signals need not be generated as described above using a key. They could be generated non-mechanically by any system that produces a first signal to arm the lock and provides a time interval in which generation of a second signal disarms the lock.

For example, the lock might include one or more sensors that produce the first signal when a first condition is detected and to arm the lock and to start a time interval within which generation of the second signal will disarm the lock. The sensor or sensors may, for example, generate the first signal when an “in use” condition is detected.

In the case of a lock for a disc brake of a motor cycle, the “in use” condition may be when the lock is locked to a disc brake. For this purpose, and referring to FIG. 6, the lock may be provided with a shock sensor 30 connected to a control circuit 31 that detects an output of the shock sensor characteristic of the lock being locked to a disc brake to produce the first signal from the claim 25. In another arrangement an infra-red sensor 32 may be provided connected to the control circuit 31. When the control circuit detects a characteristic output of the shock sensor 30, the output of the infra-red sensor 32 is received to determine whether it is characteristic of the presence of a disc brake. If it is, the first signal is produced and the time interval commences for detection of the second signal.

The second signal can, in this embodiment, be provided in any convenient way. For example, where a shock sensor 30 is present, a force may be applied to the lock in the time interval that produces from the sensor 30 a characteristic signal detected by the control circuit 31 to generate the second signal and disable the alarm 25. The force might, for example, be produced by tapping the lock in a particular way and/or at a particular area of the lock surface with the tapping being detected by a detector 33.

The signals need not be provided sequentially. There could be a first signal having a first characteristic to arm the alarm and an alternative second signal that renders the alarm inoperative. These could be produced by the use of two different keys.

The lock does not have to be a padlock of the kind described above. It could be any kind of lock having a body, a locking member that is lockable and unlockable and an alarm that can be armed and disarmed.

1. A lock comprising a body and a locking member lockable to the body and unlockable for opening movement relative to the body, the body including an alarm and an alarm trigger operable, when the locking member is locked to the body, in a first mode to activate the alarm and in a second mode to render the alarm inoperative.

2. The lock according to claim 1 wherein the alarm is activated or rendered inoperative by a electrical signal, the alarm trigger producing a first signal in said first mode and a second signal in said second mode.

3. The lock according to claim 2 wherein the second signal comprises the first signal and an additional signal.

4. The lock according to claim 3 wherein the additional signal is generated by the alarm trigger simultaneously with the first signal.

5. The lock according to claim 3 wherein the additional signal is generated by the alarm trigger after the first signal.

6. The lock according to claim 5 wherein the alarm includes an alarm control circuit, the alarm control circuit activating the alarm if only the first signal is received within a predetermined time period and rendering the alarm inoperative if, within said predetermined time period, both the first signal and the additional signal are received.

7. The lock according to claim 6 wherein signal generating means are provided operable to generate said first and said additional signals.

8. The lock according to claim 7 wherein the lock is operated by locking means to lock the locking member to the body or to unlock the locking member from the body, the locking means forming said signal generating means with operation of the locking means to lock the locking member to the body generating said first signal and subsequent operation of the locking means within said predetermined time period to unlock the locking member from the body and then to re-lock the locking member to the body generating said additional signal.

9. The lock according to claim 8 wherein the locking means is a key.

10. The lock according to claim 8 wherein the locking means is a push-button.

11. The lock according to claim 7 and including sensor means, the first signal being produced when the sensor means detects a first predetermined condition of the lock said additional signal being produced when the sensor means detects a second predetermined condition of the lock within said time period.

12. The lock according to claim 11 wherein the second predetermined condition is a user of the lock applying a force to the body.

13. The lock according to claim 11 wherein the lock is, in use, engageable with a device, the first predetermined condition being engagement of the lock with said device.

14. The lock according to claim 13 wherein the sensor means include an infra-red sensor.

15. The lock according to claim 13 wherein the sensor means include a shock sensor.

16. The lock according to claim 5 wherein a first audible signal is provided when the alarm is activated.

17. The lock according claim 5 wherein a second audible signal is provided when the alarm is rendered inoperative.
